(19) United States
(12) Patent Application Publication
(10) Pub. No.: US 2006/0209771 A1
(43) Pub. Date: Sep. 21, 2006

(54) Wireless LAN with contention avoidance

(75) Inventor: Eran Shpak, Tel Aviv (IL)

Correspondence Address: WELSH & KATZ, LTD, 120 S RIVERSIDE PLAZA, 22ND FLOOR, CHICAGO, IL, 60606, US

(73) Assignee: Extricom Ltd., Herzlia (IL)

(21) Appl. No.: 11/072,920

(22) Filed: Mar. 3, 2005

(51) Int. Cl. H04Q 7/24

(52) U.S. Cl. 370/338

(57) ABSTRACT

A method for communication includes associating a plurality of stations with an access point in a wireless local area network (WLAN), and selecting a station among the associated stations to transmit an uplink signal. The access point transmits an unsolicited Clear-To-Send (CTS) message to the stations specifying a time interval in which the selected station is to transmit the uplink signal.

### FIELD OF THE INVENTION

The present invention relates generally to wireless communications, and specifically to methods and devices for improving the performance of wireless local area networks.

### BACKGROUND OF THE INVENTION

Wireless local area networks (WLANs) are gaining in popularity, and new wireless applications are being developed. The original WLAN standards, such as “Bluetooth” and IEEE 802.11, were designed to enable communications at 1-2 Mbps in a band around 2.4 GHz. More recently, IEEE working groups have defined the 802.11a, 802.11b and 802.11g extensions to the original standard, in order to enable higher data rates. The 802.11a standard, for example, envisions data rates up to 54 Mbps over short distances in a 5 GHz band, while 802.11b defines data rates up to 22 Mbps in the 2.4 GHz band. In the context of the present patent application and in the claims, the term “802.11” is used to refer collectively to the original IEEE 802.11 standard and all its variants and extensions, unless specifically noted otherwise.

In a crowded WLAN, multiple stations may attempt to transmit at the same time. If a WLAN receiver receives signals simultaneously from two sources of similar strength on the same frequency channel, it is generally unable to decipher either signal. To deal with this problem, the 802.11 standard (Part 11: Wireless LAN Medium Access Control (MAC) and Physical Layer (PHY) Specifications, ANSI/IEEE Std 802.11, 1999 Edition) provides a distributed coordination function (DCF) for collision avoidance. The DCF is described in section 9.2 of the standard (pages 72-86), which is incorporated herein by reference.

As part of the DCF, a station in the WLAN may transmit a Request-To-Send (RTS) frame, asking to reserve the wireless medium for a subsequent data frame. Typically, the RTS frame is transmitted from a station to an access point, which responds by transmitting a Clear-To-Send (CTS) frame. The formats of the RTS and CTS frames are defined in section 7.2 of the 802.11 standard (pages 41-42), which is also incorporated herein by reference. The RTS and CTS frames specify the MAC address of the requesting station and the duration during which the medium is to be reserved for that station. All other stations receiving the RTS and/or CTS frame are expected to refrain from transmitting during the specified period, regardless of whether the stations belong to the same basic service set (BSS) as the requesting station or to a different BSS.

The 802.11 standard notes that the RTS/CTS mechanism need not be used for every data frame transmission. Because the additional RTS and CTS frames add overhead inefficiency, the mechanism is not always justified, especially for short data frames. In any case, before transmitting any frame, including RTS frames, all stations are required to performing physical carrier sensing, and to back off and refrain from transmission as long as the desired transmission channel is in use.

U.S. Patent Application Publication US 2003/0207699 A1, whose disclosure is incorporated herein by reference, describes a method for enhancing WLAN capacity using transmission power control. A first access point in the WLAN transmits a first downlink signal on a common frequency channel to a first mobile station. The power level of the downlink signal is adjusted responsively to the uplink power level of a signal transmitted from the first mobile station to the first access point. If the first downlink signal received at a second access point in the WLAN is below a predetermined interference threshold, the second access point may transmit a second downlink signal on the common frequency channel to a second mobile station, simultaneously with transmission of the first downlink signal by the first access point to the first mobile station. The capacity of the WLAN may thus be substantially increased by permitting multiple access points to transmit downlink signals on the same frequency channel at the same time, without causing mutual interference.

### SUMMARY OF THE INVENTION

When a number of stations in a WLAN share the same frequency channel, there can be intense contention for access to the channel. Because of the carrier sensing and backoff requirements of the 802.11 standard, stations may have to wait for substantial periods before they can make an uplink transmission. The latency added by the waiting period can have a particularly deleterious effect on the performance of real-time applications, such as voice or video transmission.

Embodiments of the present invention provide a novel mechanism for central management and control of uplink access in a WLAN, which may be used to resolve these problems of contention and latency. The mechanism uses unsolicited CTS messages, which are transmitted from an access point to the stations irrespectively of whether or not the stations transmit RTS messages. Each CTS message specifies the station that is to transmit the next uplink signal, along with the time interval during which the selected station may transmit. Upon receiving the CTS message, if the station specified in the message has data to transmit, the station will transmit the data during the time interval in accordance with the 802.11 standard, even if the station did not previously transmit a RTS frame. All other stations (even stations in another BSS) refrain from transmission.

In some embodiments of the present invention, an access manager in the WLAN selects the stations that are to make uplink transmissions and instructs the access point to send CTS messages accordingly. The access manager may select the stations in sequence, and thus enforces a sort of time division multiplexing (TDM) among the stations in the WLAN, in place of the uncontrolled, competitive access scenario envisioned in the 802.11 standard. This scheme can be activated and deactivated as appropriate, depending on traffic conditions in the WLAN. It is useful particularly in reducing latency and jitter in real-time applications, such as Voice over Internet Protocol (VoIP), that involve regular transmission of fixed-length data packets, but it may be used to reduce contention in transmission of all sorts of application traffic.

There is therefore provided, in accordance with an embodiment of the present invention, a method for communication, including:

associating a plurality of stations with an access point in a wireless local area network (WLAN);

selecting a station among the associated stations to transmit an uplink signal; and

transmitting an unsolicited Clear-To-Send (CTS) message from the access point to the stations specifying a time interval in which the selected station is to transmit the uplink signal.

In some embodiments, selecting the station includes selecting multiple stations among the associated stations to transmit respective uplink signals in alternation, and transmitting the unsolicited CTS message includes transmitting multiple, successive CTS messages specifying respective time intervals for uplink transmission by the multiple stations.

In a disclosed embodiment, selecting the station includes selecting the station responsively to a type of application traffic that is to be transmitted by the station. For example, selecting the station may include allocating the time interval to at least one of the stations for uplink transmission of real-time traffic.

Typically, transmitting the CTS message causes all the stations receiving the CTS message other than the selected station to refrain from uplink transmission during the specified time interval.

In a disclosed embodiment, the WLAN includes multiple access points, and including receiving the uplink signal from the selected station during the specified time interval at two or more of the access points, and selecting one of the two or more of the access points to respond to the uplink signal.

Additionally or alternatively, selecting the station includes selecting at least first and second stations among the associated stations to transmit uplink signals simultaneously, and transmitting the unsolicited CTS message includes transmitting at least first and second unsolicited CTS messages from first and second access points, respectively specifying that the first and second stations are to transmit uplink signals during the specified time interval.

There is also provided, in accordance with an embodiment of the present invention, apparatus for communication, including:

an access point, which is configured to communicate with a plurality of stations in a wireless local area network (WLAN); and

an access manager, which is operative to select a station among the plurality of stations to transmit an uplink signal, and to cause the access point to transmit an unsolicited Clear-To-Send (CTS) message to the stations specifying a time interval in which the selected station is to transmit the uplink signal.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a WLAN system with central control of uplink access, in accordance with an embodiment of the present invention;

FIG. 2 is a flow chart that schematically illustrates a method for controlling uplink access in a WLAN, in accordance with an embodiment of the present invention; and

FIG. 3 is a timing diagram that schematically illustrates a time division multiplexing scheme used in a WLAN, in accordance with an embodiment of the present invention.

### DETAILED DESCRIPTION OF EMBODIMENTS

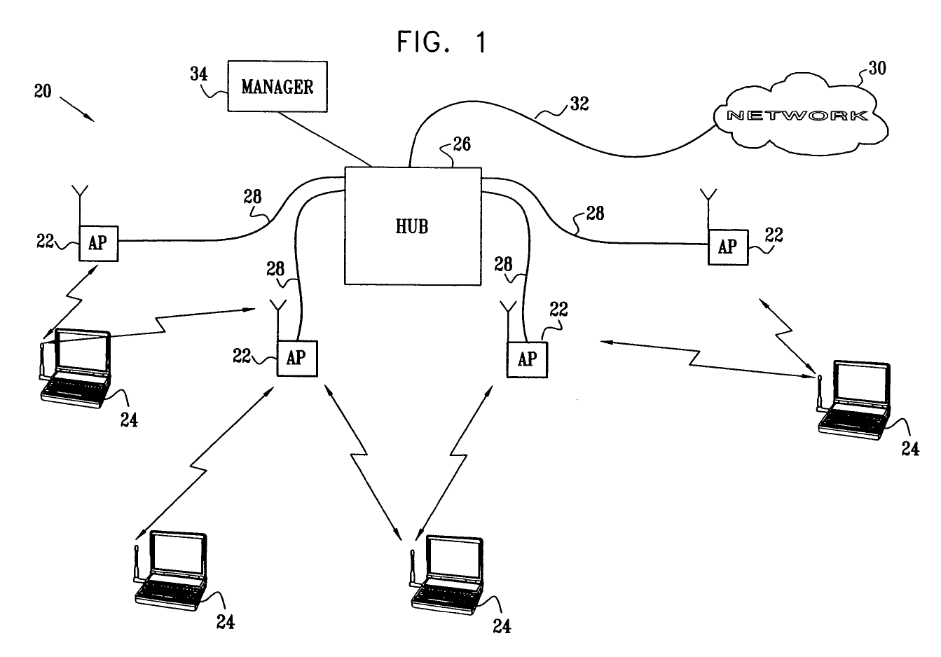

FIG. 1 is a block diagram that schematically illustrates a wireless LAN (WLAN) system 20, in accordance with a preferred embodiment of the present invention. System 20 comprises multiple access points 22, which comprise PHY and MAC interfaces for data communication with mobile stations 24. The mobile stations typically comprise computing devices, such as desktop, portable or handheld devices. In the exemplary embodiments described hereinbelow, it is assumed that the access points and mobile stations communicate with one another in accordance with one of the standards in the IEEE 802.11 family and observe the 802.11 MAC layer conventions described in the above-mentioned 802.11 standard. The principles of the present invention, however, may also be applied, mutatis mutandis, in other wireless environments, such as Bluetooth networks, personal area networks (IEEE 802.15), wireless metropolitan area networks (IEEE 802.16) and Ultra Wideband (UWB) networks.

Access points 22 are connected by a communication medium, typically comprising a wired LAN 28 with a hub 26, such as an Ethernet switching hub. LAN 28 serves as the distribution system (DS) for exchanging data between the access points and the hub. Typically, the hub is also linked to an external network 30, such as the Internet, via an access line 32, so as to enable mobile stations 24 to send and receive data through access points 22 to and from the external network.

An access manager 34 controls uplink transmissions by mobile stations 24 in system 20 by instructing access points 22 to periodically transmit unsolicited CTS messages, as described in detail hereinbelow. For conceptual clarity, manager 34 is shown as a separate unit within the system, coupled to hub 26. In practice, the function of manager 34 may be integrated into hub 26 or into one of access points 22, or distributed among the access points (assuming the hub or access points to have suitable processing resources for carrying out this function). Furthermore, although manager 34 is configured in the present embodiment to communicate with and control multiple access points in system 20, the principles of the present invention may alternatively be embodied in a single access point, for controlling use of the wireless medium in its own service area, independently of any other access points.

In some embodiments, manager 34 also controls downlink transmissions by access points 22 in order to enhance the coverage and performance of the WLAN system. In these embodiments, multiple access points with overlapping service areas operate on the same frequency channel and share the same BSS identifier (BSSID). Manager 34 selects one of access points 22 to communicate with each mobile station (usually the closest access point to the mobile station). Techniques that may be used for this purpose are described, for example, in U.S. Pat. No. 6,799,054 and in U.S. Patent Application Publications US 2003/0206532 A1, US 2004/0063455 A1 and US 2004/0156399 A1, whose disclosures are incorporated herein by reference.

Although embodiments of the present invention may require certain modifications to the functionality of conventional 802.11 access points to perform the operations described herein, the novel operation of access points 22 and manager 34 is transparent to mobile stations 24, which operate in accordance with the 802.11 standard without modification.

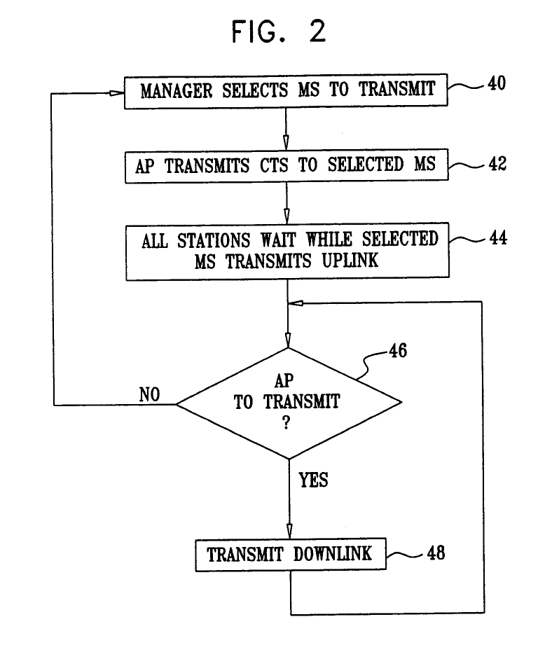

FIG. 2 is a flow chart that schematically illustrates a method for controlling uplink access by mobile stations 24 in WLAN system 20, in accordance with an embodiment of the present invention. The method assumes that manager 34 is aware of the mobile stations that are active in the service area of the WLAN. For example, the manager may keep a record of the MAC addresses of the mobile stations that are actively associated with the access points in the WLAN. Furthermore, the manager may be aware of the types of application traffic that the mobile stations are transmitting and receiving, such as real-time types of applications (such as voice) and non-real-time types (such as Web browsing or e-mail).

At certain intervals, manager 34 selects one of mobile stations (MS) 24 to transmit an uplink signal, at a station selection step 40. The manager may select from among all the mobile stations in its records or, alternatively, only from among the mobile stations that are using certain applications, such as real-time applications. In the latter case, the manager may set aside some intervals as free access intervals, during which all mobile stations are allowed to transmit uplink signals, subject to the conventional constraints of the 802.11 standard. Typically, the manager selects the mobile stations in alternation according to a fair access scheme, such as a round robin.

Manager 34 instructs the access point that is serving the selected mobile station to broadcast an unsolicited CTS message, at a CTS transmission step 42. The CTS message has the following frame format, as specified in the 802.11 standard, section 7.2.1.2:

| FRAME CONTROL | DURATION | RA | FCS |
|---|---|---|---|
| (2 octets) | (2 octets) | (6 octets) | (4 octets) |

The receiver address (RA) is the MAC address of the selected mobile station. Although the 802.11 standard envisions that CTS messages will be sent only in response to RTS messages, there is no reason why access points 22 may not send a CTS message without RTS solicitation. The response of the stations in the WLAN to the CTS message will be the same regardless of whether or not the CTS message was preceded by a RTS.

If the selected mobile station has data to transmit, it will transmit as much of the data as it can during the specified duration, at an uplink transmission step 44. (If the selected mobile station has no data to transmit, it will typically either remain silent or retransmit its previous packet.) The duration may be set equal to the time required to transmit a single application packet, such as a voice packet using a particular codec, or a number of such packets. In accordance with the 802.11 standard, the selected mobile station transmits the first packet in response to the CTS message immediately, without backoff. If the specified duration is long enough, and the selected mobile station has more than one packet to transmit, it may subsequently send one or more additional packets, after ascertaining that the wireless medium is still available in accordance with the usual DCF requirements.

All other stations receiving the CTS message at step 42 refrain from transmitting during the period specified in the duration field. As noted earlier, the restriction on transmission during the specified period applies to all stations that receive the CTS message, whether they are in the same BSS as the access point transmitting the message or in a different BSS. After receiving the uplink packet from the selected station, the access point transmits an ACK frame to acknowledge the uplink transmission.

After selecting the mobile station, manager 34 determines whether another mobile station should next be allowed to transmit, or whether it is time for a downlink data transmission, at a decision step 46. In the former case, the manager returns to step 40 to select the next mobile station, and steps 42-46 are repeated. In the latter case, the manager instructs the appropriate access point to transmit downlink data to one or more of the mobile stations, at a downlink transmission step 48. Alternatively, the manager may refrain from issuing an uplink or downlink selection for a certain period of time, during which the stations in the WLAN are free to access the wireless medium using the conventional access methods provided by the 802.11 standard. The steps of the method of FIG. 2 are then repeated, as described above.

The method of FIG. 2 has at least two complementary positive effects in reducing latency and increasing efficiency of use of the wireless medium:
(1) Collisions between transmissions by different mobile stations are avoided, so that retransmission is rarely needed. (Collisions are avoided not only among the mobile stations in a given BSS, but also among the stations in different BSSs that happen to share the same frequency channel.)
(2) The selected mobile station does not waste any time on carrier sensing or backoff before transmission.

In some cases, manager 34 may select more than one mobile station at step 40, and may instruct different access points in WLAN system 20 to transmit respective CTS messages at step 42, each specifying the MAC address of one of the different selected mobile stations. As a result, the two (or more) selected mobile stations may transmit uplink packets simultaneously at step 44. This feature of the present invention assumes that the selected mobile stations and the access points serving them are sufficiently far apart so that their transmissions will not interfere with one another. It also assumes that manager 34 has sufficient information about the levels of mutual interference among the access points and among the mobile stations to be able to choose non-interfering cohorts. A method for automatically partitioning and controlling a WLAN in this manner for purposes of downlink transmission control is described in the above-mentioned U.S. Patent Application Publication US 2003/0207699 A1. The techniques described in this publication may be extended for use in conjunction with the CTS-based methods of uplink transmission control that are described in the present patent application.

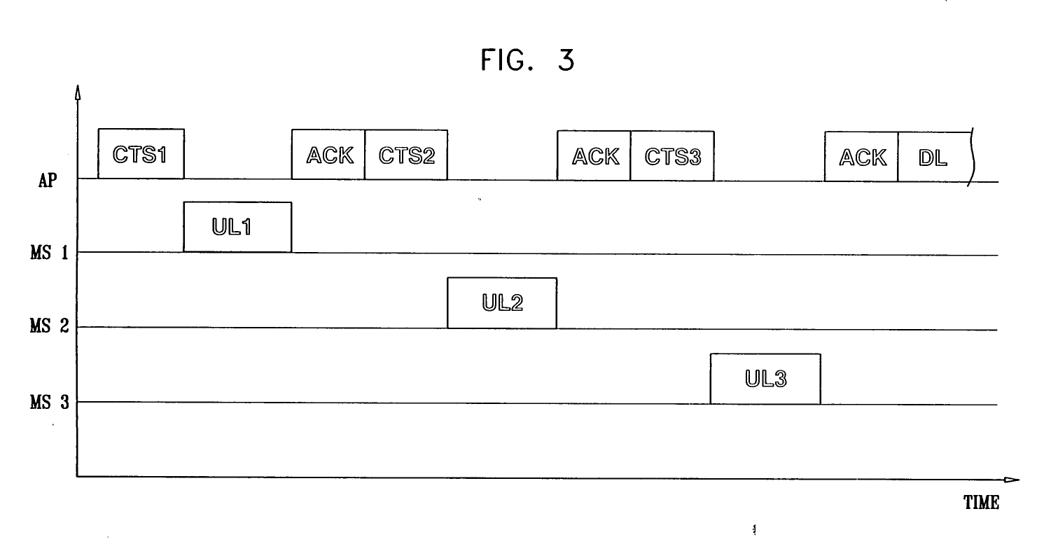

FIG. 3 is a timing diagram that schematically illustrates a time division multiplexing (TDM) scheme used in WLAN system 20, in accordance with an embodiment of the present invention. This simplified diagram shows the interaction between one access point (AP) and three mobile stations (MS1, MS2 and MS3). The access point transmits unsolicited CTS frames labeled CTS1, CTS2 and CTS3, at step 42 in the method of FIG. 2. These frames specify, in turn, the MAC addresses of the three mobile stations. Each CTS frame defines a time slot, during which the mobile stations then transmit respective uplink data frames: UL1, UL2 and UL3, which are acknowledged by the access point with an ACK frame. (In reality, the duration of the uplink transmission is generally much longer than the CTS and ACK frames, but the relative lengths of the uplink transmissions are compressed in FIG. 3 for convenience of illustration.) After all the mobile stations have had their turns at uplink transmission, the access point transmits downlink data (DL) to the mobile stations.

It can be seen in FIG. 3 that the allocation of air time in system 20 follows an orderly TDM pattern, in contrast to the random allocation of air time that characterizes conventional 802.11 WLANs. As noted earlier, this TDM pattern is useful for real-time applications, and particularly applications involving duplex transmission, such as voice and video conferencing.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication, comprising:
associating a plurality of stations with an access point in a wireless local area network (WLAN);
selecting a station among the associated stations to transmit an uplink signal; and
transmitting an unsolicited Clear-To-Send (CTS) message from the access point to the stations specifying a time interval in which the selected station is to transmit the uplink signal.

2. The method according to claim 1, wherein selecting the station comprises selecting multiple stations among the associated stations to transmit respective uplink signals in alternation, and wherein transmitting the unsolicited CTS message comprises transmitting multiple, successive CTS messages specifying respective time intervals for uplink transmission by the multiple stations.

3. The method according to claim 1, wherein selecting the station comprises selecting the station responsively to a type of application traffic that is to be transmitted by the station.

4. The method according to claim 3, wherein selecting the station comprises allocating the time interval to at least one of the stations for uplink transmission of real-time traffic.

5. The method according to claim 1, wherein transmitting the CTS message causes all the stations receiving the CTS message other than the selected station to refrain from uplink transmission during the specified time interval.

6. The method according to claim 1, wherein the WLAN comprises multiple access points, and comprising receiving the uplink signal from the selected station during the specified time interval at two or more of the access points, and selecting one of the two or more of the access points to respond to the uplink signal.

7. The method according to claim 1, wherein selecting the station comprises selecting at least first and second stations among the associated stations to transmit uplink signals simultaneously, and
wherein transmitting the unsolicited CTS message comprises transmitting at least first and second unsolicited CTS messages from first and second access points, respectively specifying that the first and second stations are to transmit uplink signals during the specified time interval.

8. Apparatus for communication, comprising:
an access point, which is configured to communicate with a plurality of stations in a wireless local area network (WLAN); and
an access manager, which is operative to select a station among the plurality of stations to transmit an uplink signal, and to cause the access point to transmit an unsolicited Clear-To-Send (CTS) message to the stations specifying a time interval in which the selected station is to transmit the uplink signal.

9. The apparatus according to claim 8, wherein the access manager is adapted to select multiple stations among the plurality of stations to transmit respective uplink signals in alternation, and to cause the access point to transmit multiple, successive CTS messages specifying respective time intervals for uplink transmission by the multiple stations.

10. The apparatus according to claim 9, wherein the access manager is adapted to select the station responsively to a type of application traffic that is to be transmitted by the station.

11. The apparatus according to claim 10, wherein the access manager is adapted to allocate the time interval to at least one of the stations for uplink transmission of real-time traffic.

12. The apparatus according to claim 8, wherein transmitting the CTS message causes all the stations receiving the CTS message other than the selected station to refrain from uplink transmission during the specified time interval.

13. The apparatus according to claim 8, wherein the WLAN comprises multiple access points, which are disposed so that two or more of the access points receive the uplink signal transmitted by the selected station, and wherein the access manager is adapted to select one of the two or more of the access points to respond to the uplink signal.

14. The apparatus according to claim 8, wherein the access point is one of a plurality of access points comprising at least first and second access points, and
wherein the access manager is adapted to select at least first and second stations among the associated stations to transmit uplink signals simultaneously, and to instruct at least the first and second access points to transmit first and second unsolicited CTS messages, respectively specifying that the first and second stations are to transmit uplink signals during the specified time interval.
